(19) United States
(12) Patent Application Publication
(10) Pub. No.: US 2020/0278960 A1
(43) Pub. Date: Sep. 3, 2020

(54) METHOD AND SYSTEM FOR DERIVING A PROCEDURE FOR QUERYING DATA

(71) Applicant: Aalto Korkeakoulusäätiö sr, AALTO (FI)

(72) Inventor: Jussi RINTANEN, Espoo (FI)

(73) Assignee: Aalto Korkeakoulusäätiö sr, AALTO (FI)

(21) Appl. No.: 16/645,573

(22) PCT Filed: Sep. 11, 2018
(86) PCT No.: PCT/FI2018/050643

§ 371 Date: Mar. 9, 2020

(30) Foreign Application Priority Data
Sep. 13, 2017 (FI) 20175810

(51) Int. Cl. G06F 16/242; G06F 16/2455

(52) U.S. Cl. CPC G06F 16/242; G06F 16/2455

(57) ABSTRACT

A method for deriving a procedure for querying data. The method includes defining a set of input parameters, defining a condition which the set of input parameters have to fulfil, analysing dependencies between input parameters of the set, creating a query structure for querying the data, based upon the analysed dependencies, and using the created query structure for querying the data. Furthermore, when the input parameters are independent, the created query structure is a single-phase query structure and when the input parameters are dependent, the created query structure is a multi-phase query structure.

### TECHNICAL FIELD

The present disclosure relates generally to querying data from users; and more specifically, to methods for deriving procedures for querying data. Furthermore, the present disclosure also relates to systems for deriving procedures for querying data.

### BACKGROUND

With advancements in computer technology, there has been an exponential increase in the amount of data being generated.

Typically, data from various sources is stored in the form of files, records, tables and the like, in a database system. When a human user interacts with a computer system, the possible courses of action are determined by input supplied by the human user. Further, the possibility of taking a given action is usually limited by some given condition. Typically, not all combinations of inputs are possible, and the user's action possibilities are limited by the condition on the inputs and the data stored in the computer system. In such a case, it is important that the human user can effectively supply only such combinations of inputs that satisfy the condition, and that the human user is capable of supplying any possible combination of inputs that satisfies the condition. This is to guarantee that the human user's abilities in using the computer system are not unnecessarily limited, and that the human user will not unnecessarily waste time by supplying input data that cannot satisfy the condition.

Presently, there are no general methods for creating query procedures that ask human users all and only allowed combinations of inputs that satisfy a given condition. Conventionally, such query procedures are devised on a case by case basis for a given condition, relying on designers intuition and experience, which has not been automated so that they could be performed by a computer program. Additionally, construction of query procedures by human designers is time consuming and error prone, and devising query procedures for complex conditions is difficult, requiring expertise that few designers of such query procedures possess. In an example, the user may require an appointment for services, for example, such as haircut, dying and the like, in a hair salon. In such an example, the user may book an appointment via a smart phone application, online application and the like. Furthermore, the user may provide an input related to the choice of a hair dresser, a time and a date at which the appointment needs to be fixed and so forth. Typically, in such an example, the user may be provided with the results associated with each of the hair dresser, the time and the date. However, in such an example, there may be an instance wherein a desired hair dresser may not be available at the provided time. As a result, the user may be requested to try again. Furthermore, such situations may cause inconvenience to the user, and also the procedure is time consuming.

Therefore, in light of the foregoing discussion, there exists a need to overcome the aforementioned drawbacks associated with the conventional techniques employed for querying data.

### SUMMARY

The present disclosure seeks to provide a method for deriving a procedure for querying data from a human user, so that a given condition will be satisfied with the supplied input data. The present disclosure also seeks to provide a system for deriving a procedure for querying data. The present disclosure seeks to provide a solution to the existing problems associated with conventional techniques of querying data. An aim of the present disclosure is to provide a solution that overcomes at least partially the problems encountered in prior art, and provides an efficient and reliable method for querying data.

In one aspect, an embodiment of the present disclosure provides a method for deriving a procedure for querying data, the method comprising:

(i) defining a set of input parameters;
(ii) defining a condition which the set of input parameters have to fulfil;
(iii) analysing dependencies between input parameters of the set;
(iv) creating a query structure for querying the data, based upon the analysed dependencies, wherein:
when the input parameters are independent, the created query structure is a single-phase query structure; and
when the input parameters are dependent, the created query structure is a multi-phase query structure; and
   (v) using the created query structure for querying the data.

In another aspect, an embodiment of the present disclosure provides a system for deriving a procedure for querying data, the system comprising a server arrangement that is configured to:

(I) define a set of input parameters;
(II) define a condition which the set of input parameters have to fulfil;
(III) analyse dependencies between input parameters of the set;
(IV) create a query structure for querying the data, based upon the analysed dependencies, wherein:
when the input parameters are independent, the created query structure is a single-phase query structure; and
when the input parameters are dependent, the created query structure is a multi-phase query structure; and
   (V) use the created query structure for querying the data.

Embodiments of the present disclosure substantially eliminate or at least partially address the aforementioned problems in the prior art, and minimizes the efforts and possibility of mistakes whilst querying the data.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B are schematic illustrations of a network environment wherein a system that, when operated, derives a procedure for querying data, in accordance with different embodiments of the present disclosure; and

FIG. 2 illustrates steps of a method of deriving a procedure for querying data, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method for deriving a procedure for querying data, the method comprising:

(i) defining a set of input parameters;
(ii) defining a condition which the set of input parameters have to fulfil;
(iii) analysing dependencies between input parameters of the set;
(iv) creating a query structure for querying the data, based upon the analysed dependencies, wherein:
when the input parameters are independent, the created query structure is a single-phase query structure; and
when the input parameters are dependent, the created query structure is a multi-phase query structure; and
   (v) using the created query structure for querying the data.

In another aspect, an embodiment of the present disclosure provides a system for deriving a procedure for querying data, the system comprising a server arrangement that is configured to:

(I) define a set of input parameters;
(II) define a condition which the set of input parameters have to fulfil;
(III) analyse dependencies between input parameters of the set;
(IV) create a query structure for querying the data, based upon the analysed dependencies, wherein:
when the input parameters are independent, the created query structure is a single-phase query structure; and
when the input parameters are dependent, the created query structure is a multi-phase query structure; and
   (V) use the created query structure for querying the data.

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The method of deriving a procedure for querying data and the system for deriving a procedure for querying data as described in the present disclosure enables efficient, effective and reliable procedure for querying data. Typically, the aforesaid method minimizes the data to be queried from a user. The user can effectively supply inputs that correctly satisfy the defined conditions. Further the method provides user with a user interface which is easier to use. Consequently, user saves time and the method reduces complexity of applications. Furthermore, the method further minimizes the input parameters of the set to be queried, thereby allowing substantial satisfaction of the defined condition. Moreover, the aforesaid method substantially minimizes efforts and possibility of mistakes whilst querying the data. Beneficially, the aforesaid system decreases human intervention in extracting useful information by performing a query procedure. Therefore, the present disclosure provides an optimal method for deriving the procedure for querying data.

In overview, embodiments of the present disclosure are concerned with a method of deriving a procedure for querying data or a system for deriving a procedure for querying data.

It will be appreciated that the aforesaid method of deriving a procedure for querying data is not limited to obtaining the queried data for only a single use case, and can be employed to obtain queried data for a plurality of use cases (namely, multiple use cases). In such a case, separate conditions are generated and are to be satisfied for each use case of the plurality of use cases.

Throughout the present disclosure, the term “querying data” as used herein relates to querying (namely, requesting) for a data (namely, information) from a human user. Data querying results can be stored for example in a database. Beneficially, the method for deriving the procedure for querying the data is implemented in various service sectors. In an example, the method can be implemented in a call center to display procedures to be followed by an employee while querying a customer upon a call via a flow diagram on a computer screen or sheet of paper. In another example, the method can be implemented in a public or private sector company to display procedures to be followed by a clerk at a service desk. In yet another example, the method can be implemented as a part of operation among user interfaces of various systems such as smart phone apps, desktop computer programs, Web pages, cash registers, automated teller machine (ATM), vending machines and the like.

The method for deriving the procedure for querying the data comprises defining the set of input parameters. Throughout the present disclosure, the term “input parameters” used herein relates to a specific set of input parameters defined by a given procedure for querying the data. In other words, the input parameters relate to a set of variables defined by a given procedure for querying the data. Notably, the set of variables of the input parameters are defined depending upon a use case of the data to be queried. In a first example, a customer may book a service (for example, such as haircut, hair dye and the like) in a hair salon for a given date and a given time. In such an example, the defined set of input parameters may include a time slot, a date, services and a preferred hairdresser.

The input parameters include, but are not limited to Boolean parameters, finite-valued parameters, real-valued parameters, integer-valued parameters, set-valued parameters, list-valued parameters, array-valued parameters, or a combination thereof.

Typically, the Boolean parameters consist of simple propositional set of variables. Furthermore, such propositional set of variables may be determined as either true (namely, yes) or false (namely, false). The finite-valued parameters consist of finite valued variable. In an example, a variable x: {v₁, . . . , vₙ} may be a finite-valued variable. In such an example, the variable x can have any of the values {v1, . . . , vₙ}. The real-valued parameters consist of an infinite valued numeric variable. The integer-valued parameters comprise of integer valued variables. The parameters with relational constraints comprise of variables that may be represented by data in a relational database. Furthermore, the input parameters can be a combination of the aforementioned parameters.

The method comprises defining the condition which the set of input parameters have to fulfill. Throughout the present disclosure, the term “condition” used herein relates to a situation (namely, requirement) that the defined set of input parameters have to fulfill, typically so that some given task or tasks can be performed. In such a case, the allowed values for the input parameters are extracted in a manner that the defined condition is to be fulfilled. Furthermore, in the first example, the defined condition which the set of input parameters have to fulfill may be the availability of the hairdresser at the preferred time slot and the preferred date. Therefore, choosing a given date and time slot thereby limits the choice of the hairdresser. Alternatively, in the first example, choosing a hairdresser available for the service first, thereby limits the choice of the time slot and date.

Optionally, the condition defined at (ii) comprises a set of atomic conditions that are inter-related via Boolean connectives, the set of atomic conditions being numeric conditions and/or relational conditions. The term “atomic conditions” used herein relates to plurality of situations (namely, requirement) that upon combination via Boolean connectives (such as AND, OR and NOT) comprises the defined condition which the input parameters of the set have to fulfill. As mentioned in the first example, the defined condition ‘A’ comprising the set of atomic conditions may include a first atomic condition ‘A1’ that the hairdresser is capable of providing the service, a second atomic condition ‘A2’ that the hairdresser is available on the preferred date and a third atomic condition ‘A3’ that the hairdresser is available in the preferred time slot. In such a case, the defined condition ‘A’ which the set of input parameters have to fulfill the set of atomic conditions ‘A1’, ‘A2’ and ‘A3’ that are inter-related via Boolean connective AND as:

A=‘A1’ AND ‘A2’ AND ‘A3’

Optionally, the method further comprises evaluating a sub-set of the set of atomic conditions wherein the sub-set of the set of atomic conditions do not refer to values of the input parameters, to obtain a condition-on-parameters (ϕ).

Optionally, the method further comprises creating a decision tree, which represents the possible alternative results of evaluating the set of atomic conditions which do not contain occurrences of the input parameters, and for each leaf node of the decision tree, which correspond to a particular value combination of the said atomic conditions, simplifying the condition by using appropriate logical equalities, to obtain at a condition-on-parameters (ϕ). This moves complex logical reasoning from the time of executing the query procedure to the time of constructing the query procedure. Consequently, the query procedure can be executed faster and without an understanding of the logical reasoning involved.

Throughout the present disclosure, the term “a condition-on-parameters (ϕ)” as used herein relates to at least one or more atomic conditions combined with Boolean connectives, wherein the atomic conditions refer to the input parameters. In the first example, the user may be operable to select a particular hairdresser. Furthermore, the condition-on-parameters (ϕ) corresponds to a combination of the second atomic condition ‘A2’ regarding the preferred date associated with the particular selected hairdresser and a third atomic condition ‘A3’ regarding the preferred time slot associated with the particular selected hairdresser. In such an example, the user may select a hairdresser ‘H’, a preferred date ‘D’, and a preferred time ‘T’. Subsequently, the condition-on-parameters (ϕ) can be defined as:

(‘Hairdresser is H’ AND ‘H is available at the preferred date D’ AND ‘H is available at the preferred time T’)

Optionally, evaluating the set of atomic conditions comprises employing at least one decision tree and/or at least one branching operation. The term “decision tree” used herein relates to a specialized technique that employs a tree-like model (namely, a graph) of decisions and the results corresponding thereto. The decision tree is a decision support tool. Typically, the decision tree employs a tree-like graph or model of decisions to map the possible results of a series of related possibilities. Additionally, the decision tree starts with a single node (namely, branch node). Furthermore, the branch node branches into possible outcomes. Moreover, each of the possible outcomes may branch out into other possibilities. Consequently, the end nodes (namely, leaf nodes) of the decision tree remit all the possible results of a series of related possibilities. Alternatively the evaluating condition comprises employing at least one decision tree and/or at least one branching operation.

Typically, the branching operation creates a plurality of copies of a given atomic condition/condition in a plurality of parallel versions. Furthermore, throughout the operation, the original condition is retained and changes are made in the plurality of copies of the given atomic condition/condition in the plurality of parallel versions. Furthermore, each copy of the given atomic condition/condition is generated as a result of the branching of the given atomic condition/condition. Consequently, the branching operation facilitates isolated changes to be made to the given atomic condition/condition.

The at least one decision tree and/or the at least one branching operation comprises branch nodes and leaf nodes, wherein the branch nodes correspond to the atomic conditions which do not refer to values of the input parameters and the leaf nodes are associated with the formulas that are obtained from the defined condition by replacing the aforesaid set of atomic conditions by the values indicated for them on the path from the root node of the decision tree to the leaf node. Therefore, the set of atomic conditions in the leaf nodes can refer to the input parameters. The formulas in the leaf nodes of the decision tree are conditions-on-parameters, as they only refer to the input parameters and not to other variables. Typically, the condition-on-parameters (ϕ) is derived once a branching operation checks (or tests) the fulfillment of a condition associated therewith. Typically, the branching operation is the atomic condition that does not depend on the input parameters. However, depending upon the results of the atomic condition of the branching operation, exactly one of the condition-on-parameters (ϕ) is determined for each leaf node of the decision tree.

In one example, the value of a leaf node may be FALSE when the defined condition cannot be satisfied by any values of the input parameters, because the atomic conditions unrelated to the input parameters alone determine the falsity of the condition. In another example, the value of a leaf node may be TRUE when the defined condition is satisfied by all values of the input parameters. Furthermore, in such an example, values of the input parameters may be queried if they are needed for other purpose. In a second example, a service may allow a new customer to place an order for up to ten items and an existing customer can order any number of items considering the availability of the stock. In such an example, the set of atomic conditions include a first atomic condition ‘B1’ that the customer is new, a second atomic condition ‘B2’ that the number of items to be ordered is less than 10 and a third atomic condition ‘B3’ that the number of items ordered is available in stock. The input parameter is the number of items ordered. The newness of a customer is not an input parameter. Furthermore, in such an example, the branch node corresponds to the first atomic condition ‘B1’ that the customer is new. In such an example, the condition can be defined as:

(‘Customer is new’ AND ‘order≤10’ AND ‘order stock’) OR (‘customer is not new’ AND ‘order stock’)

In the second example, when the customer is new, the condition-on-parameters (ϕ) corresponds to a combination of the second atomic condition ‘B2’ that the number of items to be ordered is less than 10 and the third atomic condition ‘B3’ that the number of items to be ordered is available in stock via the Boolean connective “AND”. In a second case, when the customer is not new (namely, existing customer) the condition-on-parameters (ϕ) corresponds to the third atomic condition ‘B3’ that the number of items to be ordered is available in stock.

The at least one decision tree and/or the at least one branching operation is employed to select a condition-on-parameters which does not refer to variables such as the newness of a customer that are not input parameters. Notably, the at least one decision tree and/or the at least one branching operation generates a plurality of conditions-on-parameters. Furthermore, such conditions-on-parameters are analyzed and employed to determine possible values for the input parameters. In the second example, the first branching of the decision tree is with ‘type of customer’. For the case in which the customer is new, the condition-on-parameters in the corresponding leaf node of the decision tree is B2 AND B3. Furthermore, in such case, the input parameter may be the ‘quantity’ of the order. The selectable option (such as, the choice) provided to the user for selecting the quantity of the selected product may be up till 10, if 10 or more items of the selected product is available in stock. Alternatively, if the number of items of the selected product available in stock is less than 10, in such a case, the selectable option provided to the user is limited to the number of items available in stock. For the case in which the customer is not new, the condition-on-parameters in the corresponding leaf node of the decision tree is B3. Moreover, if the customer is not new, in such case, the condition such as the third atomic condition ‘B3’ holds. Furthermore, the user may select the quantity of the order as the input parameter. Consequently, the input parameter (namely, quantity) is limited to the number of items available in stock.

Optionally, the condition-on-parameters (ϕ) is in one of Boolean circuit, unrestricted Boolean formula or a Negation Normal Form (NNF).

The method comprises analyzing the dependencies between input parameters of the set. Throughout the present disclosure, the term “dependency” used herein relates to associations between the input parameters of the set. In other words, the dependency between the input parameters of the set refers to the associations of a given input parameters of the set with respect to the other input parameters of the set. Furthermore, the dependencies of the given input parameters of the set are identified to be independent or dependent with respect to the other input parameters of the set.

In an embodiment, ‘x’ and ‘y’ may be input parameters of the query procedure. Furthermore, in an example, a condition associated with the input parameters ‘x’ and ‘y’ may be

0≤x AND x≤10 AND 0≤y AND y≤5

In such case, the possible values of the input parameter ‘x’ and the possible values of the input parameter ‘y’ are independent of each other. Consequently, the value of the input parameters ‘x’ and ‘y’ can be asked and supplied in any order. In another example, a condition associated with the input parameters ‘x’ and ‘y’ may be

x>y

In such case, the possible values of the input parameter ‘x’ and the possible values of the input parameter ‘y’ are inter-dependent. In other words, if the user first gives a certain value to the input parameter ‘x’, then the values allowed for the input parameter ‘y’ is lower than the value of the input parameter ‘x’ and if the user first gives a certain value to the input parameter ‘y’, then the values allowed for the input parameter ‘x’ is higher than the value of the input parameter ‘y’. Consequently, the values of the input parameters ‘x’ and ‘y’ are asked separately and one after the other. In yet another example, a condition associated with the input parameters ‘x’ and ‘y’ may be

x>0 OR y>0

in such a case, the possible values of the input parameter ‘x’ and the possible values of the input parameter ‘y’ are inter-dependent. Subsequently, if the user gives a value for the input parameter ‘x’ greater than 0, in such case, the input parameter ‘y’ is allowed any integer value, and vice-versa. If the users give the input parameter ‘x’ the value 0 or a any negative integer, then only positive integer values are allowed to the input parameter ‘y’.

Optionally, analysing the dependencies between the input parameters of the set at (iii) is based upon the set of atomic conditions and/or the one condition-on-parameters (ϕ), and wherein:
a given input parameter (p) of the set is identified to be independent with respect to other input parameters of the set, when the condition-on-parameters (ϕ) is logically equivalent to a formula of the form ϕₚ AND ϕ′, wherein
(a) p occurs in ϕₚ;
(b) p does not occur in ϕ′; and
(c) the other input parameters of the set do not occur in ϕₚ; and
a dependency is identified between the given input parameter (p) and another input parameter (q) of the set, when
(d) the given input parameter (p) and the another input parameter (q) occur together in at least one atomic condition; or
(e) the given input parameter (p) and the another input parameter (q) occur disjunctively in the condition-on-parameters (ϕ)—within a sub-formula of the form ϕₚ OR ϕ_{q}, wherein p occurs in ϕₚ and q occurs in ϕ_{q} provided that the condition-on-parameters (ϕ) has been transformed to Negation Normal Form.

In one case, the given parameter of the set may be identified to be independent with respect to other input parameters of the set. Optionally, the given input parameter (p) of the set is identified to be independent with respect to the other input parameters of the set, when the condition-on-parameters (ϕ) is logically equivalent to a formula of the form ϕₚ AND ϕ′. In such a case, the possible values of the given input parameter (p) occur in the set of atomic conditions occurring in ϕₚ. Furthermore, the values of the given input parameter (p) do not occur in the set of atomic conditions occurring in ϕ′. As a result, the possible values of the given input parameter (p) are limited by the set of atomic conditions occurring in ϕₚ. Furthermore, the other input parameters of the set do not occur in the set of atomic conditions occurring in ϕₚ. In such a case, the possible values of the given input parameter (p) are obtained from ϕₚ by enumerating all values of p that make ϕₚ true, by employing standard solution enumeration methods. If p is a numeric input parameter and has very many or an infinite number of values, then upper and lower bounds or possible value intervals can be derived from ϕₚ by standard means. For example, the set of input parameters may have a first input parameter ‘X’ and a second input parameter ‘Y’. In such an example, the first input parameter ‘X’ and the second input parameter ‘Y’ may be numeric input parameters which have to fulfill the following condition-on-parameters ‘ϕ’:

ϕ=(0≤X) AND (X≤10) AND (0≤Y) AND (Y≤5)

Furthermore, in such an example, the values of the first numeric input parameter ‘X’ may be determined by condition ϕ_{X} that is (0≤X) AND (X≤10). Similarly, the values of the second numeric input parameter ‘Y’ may be determined by the set atomic conditions and the condition-condition (ϕ_{Y}) that is (0≤Y) AND (Y≤5). Therefore, the values of the first numeric input parameter ‘X’ and the second numeric input parameter ‘Y’ are independent.

Alternatively, optionally, a dependency is identified between the given input parameter (p) and another input parameter (q) of the set, when the given input parameter (p) and the another input parameter (q) occur in at least one atomic condition; or the given input parameter (p) and the another input parameter (q) occur disjunctively in the condition-on-parameters (ϕ) within a sub-formula of the form ϕₚ OR ϕ_{q}, wherein p occurs in ϕₚ and q occurs in ϕ_{q} provided that the condition-on-parameters (ϕ) has been transformed to Negation Normal Form. In such a case, values of the given input parameter (p) of the set may be identified to be dependent of the another input parameter (q) of the set. In an example, the first numeric input parameter ‘X’ and the second numeric input parameter ‘Y’ may have to fulfil the following condition-on-parameters ‘ϕ’:

ϕ=Y≤X

Furthermore, in such an example, when the value of the first numeric input parameter ‘X’ is fixed, then according to the condition-on-parameters ‘ϕ’ all the possible values of the second numeric input parameter ‘Y’ has to be less than or equal the value of the first numeric input parameter ‘X’. Alternatively, when the value of the second numeric input parameter ‘Y’ is fixed, then according to the condition ‘ϕ’ all the possible values of the first numeric input parameter ‘X’ have to be greater than or equal the value of the second numeric input parameter ‘Y’. Therefore, the values of the first numeric input parameter ‘X’ and the second numeric input parameter ‘Y’ are dependent upon each other.

In another example, the first numeric input parameter ‘X’ and the second numeric input parameter ‘Y’ may have to fulfil the following condition-on-parameters ‘ϕ’:

ϕ=(0≤X) OR (0≤Y)

Furthermore, in such an example, when the value of the first numeric input parameter ‘X’ is fixed in a manner such that the value of the first numeric input parameter ‘X’ is greater than or equal to 0, then according to the condition ‘ϕ’ the any value of the second numeric input parameter ‘Y’ is allowed. Alternatively, when the value of the second numeric input parameter ‘Y’ is fixed in a manner such that the value of the second numeric input parameter ‘Y’ is greater than or equal to 0, then according to the condition ‘ϕ’ then any value of the first numeric input parameter ‘X’ is allowed. Furthermore, in such an example, if user provides the first numeric input parameter ‘X’ with value which is less than 0 then Y must satisfy condition 0≤Y. Similarly, if the user provides Y with a value which is less than 0 then X must satisfy condition 0≤X. Therefore, the values of the first numeric input parameter ‘X’ and the second numeric input parameter ‘Y’ are dependent upon each other.

The method comprises creating the query structure for querying the data, based upon the analyzed dependencies. Throughout the present disclosure, the term “query structure” used herein relates to specialized sequence in which the input parameters of the set that needs to be queried. Furthermore, different query structure is followed for querying the data based upon the analysed dependencies between the input parameters of the set. Moreover, the single-phase query structure is created for querying the data when the input parameters of the set are independent. In such a case, the given input parameter (p) of the set is identified to be independent with respect to the other input parameters of the set. Furthermore, the possible values of the input parameters of the set are obtained substantially simultaneously, when the input parameters of the set are independent. Furthermore, the multi-phase query structure is created for querying the data when the input parameters of the set are dependent. In such a case, the given input parameter (p) of the set is identified to be dependent with respect to the another input parameter(q) of the set. Furthermore, in such a case, the possible values of the input parameters of the set are obtained substantially sequentially, when the input parameters of the set are dependent.

Optionally, the single-phase query structure enables the input parameters of the set to be queried independently from each other, in a an arbitrary order. The term “single-phase query structure” used herein relates to specialized technique for querying the data, thereby allowing to query a given set of independent input parameters in the arbitrary order. In other words, multiple independent input parameters of the set are queried at the same time in the single-phase query structure. In an example, a user interface may have several fields, shown simultaneously on the display to be queried by employing the single-phase query structure. For example, a user may want to calculate an amount of calorie to be consumed for a given day using a calorie calculator. In such an example, the set of input parameters may require inputs from the user based upon an age of the user, a weight of the user, a form of physical exercise performed by the user, a regular routine of the user. Furthermore, in such an example, the input parameters of the calorie calculator are independent from each other, thereby allowing the user to input the values of the above mentioned input parameters in an arbitrary manner. Moreover, the calorie calculator may calculate a portion associated with the food that should be consumed by the user based upon the user's input corresponding thereto.

Optionally, the multi-phase query structure enables the input parameters of the set to be queried based upon the dependencies therebetween, in a sequential manner. The term “multi phase query structure” used herein relates to specialized technique for querying the data, thereby allowing to query a given set of dependent input parameters in the sequential manner. In other words, the values for the input parameters of the set are queried in a sequential manner based upon the dependencies with the input parameters of the set. In an example, possible values of a given input parameter of the set are limited by choices of another input parameters. In such an example, the values for the given input parameter of the set is asked one by one in a sequential manner, with all the possible values of the another input parameters.

Optionally, in the multi-phase query structure,
a first phase pertains to
partitioning the inputs to one or more sub-sets of mutually dependent input parameters,
determining a condition for each of the subset, wherein all input parameters of a given sub-set are queried sequentially;
a second phase pertains to defining a sequence of querying for each sub-set;
a third phase pertains to querying values and determining constraints for all elements of the sequence with respect to the condition-on-parameters, by fixing values of preceding elements of a given element, and eliminating succeeding elements of the given element. Preceding elements refer to all ready queried elements. Furthermore the different sub-sets can be queried in any order or interleaved in any manner.

The term “sequence” used herein relates to an order in which the input parameters of the set need to be queried. For example, a given set of input parameters may include input parameters P1, P2, P3, P4 and P5, wherein all these five input parameters are directly or indirectly dependent on each other. In such an example, the first phase pertains to define the sequence of querying, thereby, for example, defining the sequence for querying as P1, P2, P3, P4 and P5, although any other ordering of these five inter-dependent input parameters would be possible too. According to this ordering, the value for the input parameter P1 is to be queried from the user first. In this second phase of the query method, the possible values for each of the input parameters, which will be offered to the user to be chosen from, are determined by fixing the values of preceding elements of the given element, and eliminating the succeeding elements of the given element. As a result, for the first input parameter P1, values of no other input parameters have been fixed so far. Given the condition-on-parameters ϕ, the input parameters P2, P3, P4 and P5 are eliminated with their respective variable elimination methods. The resulting condition contains only occurrences of the input parameter P1, from which possible values for P1 can be determined by standard solution enumeration methods or—in case of input parameters with large or infinite value ranges—by extracting upper and lower bounds or possible value ranges from the formula. When the user has chosen one of the possible values for the input parameter P1, the value of P1 is fixed in ϕ, and to obtain possible values for P2, the input parameters P3, P4 and P5 are similarly eliminated by their respective variable elimination methods. After the user has supplied a value for P2, the same process is repeated for P3, P4, and P5, thereby obtaining values for all input parameters.

For example, a given set of input parameters may include input parameters S1, S2, S3, S4 and S5, wherein

S1 and S2 are mutually dependent, S3 and S4 are mutually dependent, and S5 is independent of all other input parameters. Thereby, the first phase pertains to splitting the set of input parameters into the sub-sets {S1,S2}, {S3,S4} and {S5}, which correspond to the conditions C1, C2 and C3, respectively, where the condition of parameters ϕ=C1 AND C2 AND C3. The second phase pertains to choosing orderings for each of the sub-sets. For example, the ordering for S1 and S2 can be chosen to be S1 followed by S2, and the ordering for S3 and S4 can be chosen to be S3 followed by S4. Furthermore, the third phase pertains to determining the constraints for all the elements of the sequence with respect to the condition-on-parameters and the values for the input parameters earlier in the sequence, by fixing the values of preceding elements of the given element, and eliminating the succeeding elements of the given element. As a result, the possible values for S1 are obtained by eliminating S2 from C1 and obtaining the values for S1 from the resulting condition. After one of the possible values for S1 has been chosen, the possible values for S2 are determined by fixing the value for S1 in C1, and determining the possible values for S2 from the resulting condition. Values for S3 and S4 and obtained similarly, by choosing a value for S3 from the condition obtained from C2 by eliminating S4, and then choosing a value for S4 given the value for S3 from the condition obtained from C2 by fixing S3. The possible values for S5 are obtained from the condition C3. The determination of the values of the given input parameters is continued in the defined sequence of querying the data in the multi-phase query structure until all the input parameters have a defined value.

Optionally, eliminating the succeeding elements of the given element comprises:
eliminating at least one element using numeric inequalities.

Furthermore, eliminating the succeeding elements of the given element is performed by employing various elimination procedures for example, such as the forgetting or existential abstraction operation for Boolean variables, and various variants of the Fourier-Motzkin elimination procedure for integer and real valued input parameters, relational algebra's projection operations for input parameters related by relational constraints, and the like.

In yet another example, the element may be an input parameter with relational constraints. In such an example, the elimination of the succeeding elements may employ relational algebra operations or relational projection operations.

The method comprises using the created query structure for querying the data. Furthermore, the created query structure is employed for querying the data. Moreover, the method minimizes the number of input parameters to be queried and offer the narrowest possible set of answer operations, when the input parameters to be queried have to fulfill the defined condition expressed as the Boolean combination of the set of atomic conditions on numeric, Boolean and other input parameters. Typically, the user provides the data for querying. The data for querying is acquired from the user using a computing device associated with the user.

Throughout the present disclosure, the term “computing device” relates to an electronic device associated with (or used by) a user that is capable of enabling the user to perform specific tasks associated with the aforementioned method. Furthermore, the computing device is intended to be broadly interpreted to include any electronic device that may be used for voice and/or data communication over a wired or a wireless communication network. Examples of computing devices include, but are not limited to, cellular phones, personal digital assistants (PDAs), handheld devices, wireless modems, laptop computers, personal computers, etc. Additionally, the user equipment includes at least one of a casing, a memory, a processor, a network interface card, a microphone, a speaker, a keypad, and a display.

Optionally, the data provided by the user is acquired using the computing devices. Furthermore, the acquired data is transferred to a server arrangement via a wired or wireless communication network. Throughout the present disclosure, the term “communication network” relates to an arrangement of interconnected programmable and/or non-programmable components that are configured to facilitate data communication between one or more computing devices and the server arrangement, whether available or known at the time of filing or as later developed. Furthermore, the communication network may include, but is not limited to, one or more peer-to-peer network, a hybrid peer-to-peer network, local area networks (LANs), radio access networks (RANs), metropolitan area networks (MANS), wide area networks (WANs), all or a portion of a public network such as the global computer network known as the Internet, a private network, a cellular network and any other communication system or systems at one or more locations. Additionally, the communication network includes wired or wireless communication that can be carried out via any number of known protocols, including, but not limited to, Internet Protocol (IP), Wireless Access Protocol (WAP), Frame Relay, or Asynchronous Transfer Mode (ATM).

Furthermore, the system for deriving the procedure for querying data comprises the server arrangement that is configured to operate via the aforesaid method. Throughout the present disclosure, the term “server arrangement” relates to a structure and/or module that include programmable and/or non-programmable components configured to store, process and/or share information. Optionally, the server arrangement includes any arrangement of physical or virtual computational entities capable of enhancing information to perform various computational tasks. Furthermore, it should be appreciated that the server arrangement may be both single hardware server arrangement and/or plurality of hardware server arrangements operating in a parallel or distributed architecture. In an example, the server arrangement may include components such as memory, a processor, a network adapter and the like, to store, process and/or share information with other computing components, such as user device/user equipment. Optionally, the server arrangement is implemented as a computer program that provides various services (such as database service) to other devices, modules or apparatus.

In an embodiment, the server arrangement is operable to define the set of input parameters, define the condition which the set of input parameters have to fulfill, analyse dependencies between input parameters of the set and creating a query structure for querying the data, based upon the analysed dependencies. Notably, the server arrangement performs at least one of: a mathematical formula, and an artificial intelligence algorithm to perform the aforementioned methods.

More optionally, the server arrangement may be coupled to a database arrangement, wherein the database arrangement is operable to store the data (namely, information) pertaining to the query of the user. Throughout the present disclosure, the term ‘database arrangement’ as used herein relates to an organized body of digital information regardless of the manner in which the data or the organized body thereof is represented. Optionally, the database arrangement may be hardware, software, firmware and/or any combination thereof. For example, the organized body of related data may be in the form of a table, a map, a grid, a packet, a datagram, a file, a document, a list or in any other form. The database arrangement includes any data storage software and systems, such as, for example, a relational database like IBM DB2 and Oracle 9. Optionally, the database arrangement may be used interchangeably herein as database management system, as is common in the art. Furthermore, the database management system refers to the software program for creating and managing one or more databases. Additionally, the database arrangement is populated by data elements. Furthermore, the data elements may include data records, bits of data, cells, are used interchangeably herein and all intended to mean information stored in cells of a database.

Optionally, the condition defined at (II) comprises a set of atomic conditions that are inter-related via Boolean connectives, the set of atomic conditions being numeric conditions and/or relational conditions.

Optionally, the system comprises the server arrangement configured to:
process the condition defined at (II), to existentially abstract the set of atomic conditions corresponding thereto; and
evaluate the set of atomic conditions without utilising values of the input parameters, to obtain condition-on-parameters (ϕ).

Optionally, the system comprises the server arrangement operable to evaluate the set of atomic conditions by employing at least one decision tree and/or at least one branching operation.

Optionally, the system generates the condition-on-parameters (ϕ) in a Negation Normal Form (NNF).

Optionally, the system includes the server arrangement configured to analyse the dependencies between the input parameters of the set at (Ill), based upon the set of atomic conditions and/or the condition-on-parameters (ϕ), and wherein:
a given input parameter (p) of the set is identified to be independent with respect to other input parameters of the set, when the condition-on-parameters (ϕ) is logically equivalent to a formula of the form ϕₚ AND ϕ′, wherein
   (A) p occurs in ϕₚ;
   (B) p does not occur in ϕ′; and
   (C) the other input parameters of the set do not occur in ϕₚ, and
a dependency is identified between the given input parameter (p) and another input parameter (q) of the set, when
   (D) the given input parameter (p) and the another input parameter (q) occur in at least one atomic condition; or
   (E) the given input parameter (p) and the another input parameter (q) occur in the condition-on-parameters (ϕ) within a sub-formula of the form ϕₚ OR ϕ_{q}, wherein p occurs in ϕₚ and q occurs in ϕ_{q} provided that the condition-on-parameters (ϕ) has been transformed to NNF.

Optionally, the system generates the single-phase query structure that enables the input parameters of the set to be queried independently from each other, in an arbitrary manner.

Optionally, the system generates the multi-phase query structure that enables the input parameters of the set to be queried based upon the dependencies therebetween, in a sequential manner.

More optionally, in the multi-phase query structure,

a first phase pertains to
partition the inputs to one or more sub-sets of mutually dependent input parameters,
determine a condition for each of the subset, wherein all input parameters of a given sub-set are queried sequentially;
a second phase pertains to define a sequence of querying for each sub-set;
a third phase pertains to query of values and to determine constraints for all elements of the sequence with respect to the condition-on-parameters, by fixing values of preceding elements of a given element, and eliminating succeeding elements of the given element. Preceding elements refer to all ready queried elements. Furthermore the different sub-sets can be queried in any order or interleaved in any manner.

Optionally, the system comprises the server arrangement configured to eliminate the succeeding elements of the given element via:
elimination of at least one element using numeric inequalities.

### DETAILED DESCRIPTION OF THE DRAWINGS

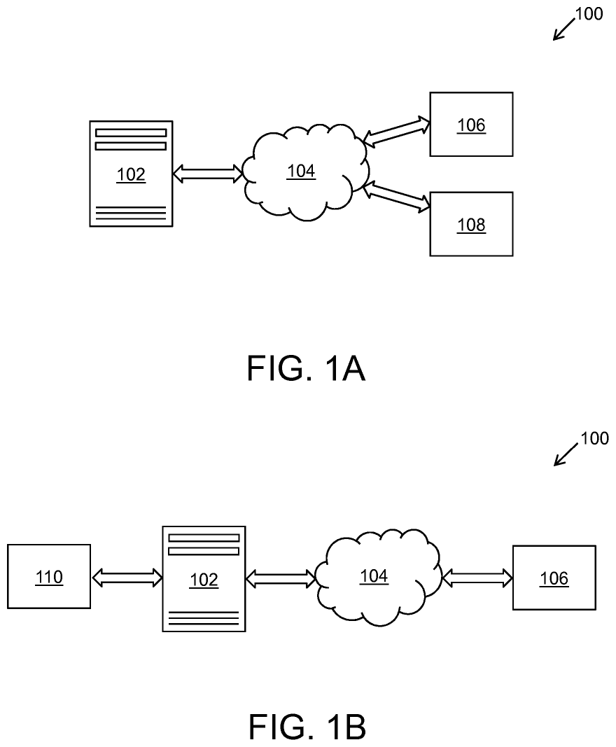

Referring to FIGS. 1A and 1B, illustrated are schematic illustrations of a network environment 100 wherein a system for deriving a procedure for querying data, in accordance with different embodiments of the present disclosure. Notably, the network environment 100 includes: a server arrangement 102 including at least one server, a communication network 104, a user device such as the user devices 106 and 108 associated with a user of the system for deriving a procedure for querying data. As shown, in the network environment 100, the server arrangement 102 is coupled in communication with the user device such as the user devices 106 and 108 via the communication network 104.

In FIG. 1B, the server arrangement 102 is further coupled in communication with a database arrangement 110.

It will be appreciated that FIG. 1 is merely an example, which should not unduly limit the scope of the claims herein. It is to be understood that the specific designation for the network environment 100 is provided as an example and is not to be construed as limiting the network environment 100 to specific numbers, types, or arrangements of user devices, servers, sources of input data, and communication networks. A person skilled in the art will recognize many variations, alternatives, and modifications of embodiments of the present disclosure.

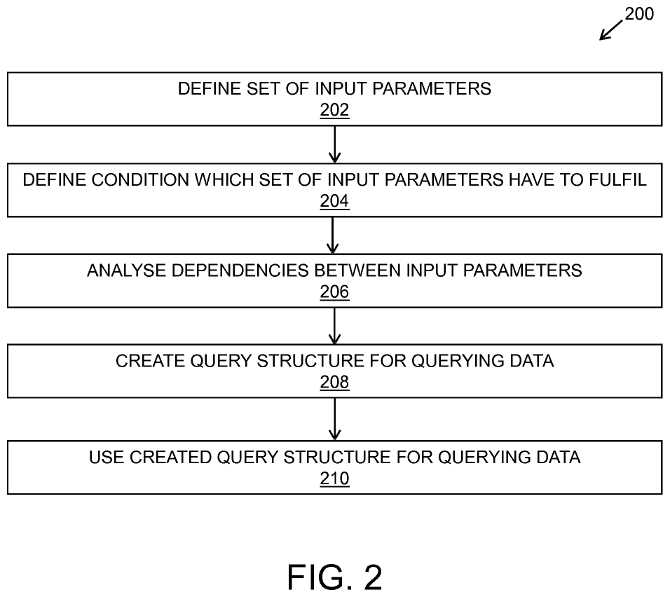

Referring to FIG. 2, illustrated are steps of a method 200 of deriving a procedure for querying data, in accordance with an embodiment of the present disclosure. At a step 202, a set of input parameters is defined. At a step 204, a condition which the set of input parameters have to fulfil is defined. At a step 206, dependencies between input parameters of the set is analysed. At a step 208, a query structure for querying the data is created based upon the analysed dependencies. Typically, when the input parameters are independent, the created query structure is a single-phase query structure and when the input parameters are dependent, the created query structure is a multi-phase query structure. At a step 210, the created query structure is used for querying the data.

The steps 202 to 210 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for deriving a procedure for querying data, the method comprising:
(i) defining a set of input parameters;
(ii) defining a condition which the set of input parameters have to fulfil;
(iii) analysing dependencies between input parameters of the set;
(iv) creating a query structure for querying the data, based upon the analysed dependencies, wherein:
when the input parameters are independent, the created query structure is a single-phase query structure; and
when the input parameters are dependent, the created query structure is a multi-phase query structure; and
(v) using the created query structure for querying the data.

2. A method according to claim 1, wherein the condition defined at (ii) comprises a set of atomic conditions that are inter-related via Boolean connectives, the set of atomic conditions being numeric conditions and/or relational conditions.

3. A method according to claim 1, wherein the method further comprises:
evaluating a sub-set of the set of atomic conditions wherein the sub-set of the set of atomic conditions do not refer to values of the input parameters, to obtain a condition-on-parameters (ϕ).

4. A method according to claim 3, wherein evaluating the set of atomic conditions comprises employing at least one decision tree and/or at least one branching operation.

5. A method according to claim 3, wherein the condition-on-parameters (ϕ) is in one of: Boolean circuit, unrestricted Boolean formula or a Negation Normal Form (NNF).

6. A method according to claim 3, wherein analysing the dependencies between the input parameters of the set at (iii) is based upon the set of atomic conditions and/or the one condition-on-parameters (ϕ), and wherein:
a given input parameter (p) of the set is identified to be independent with respect to other input parameters of the set, when the one condition-on-parameters (ϕ) is logically equivalent to a formula of the form ϕₚ AND ϕ′, wherein
(a) p occurs in ϕₚ;
(b) p does not occur in ϕ′; and
(c) the other input parameters of the set do not occur in ϕₚ; and
a dependency is identified between the given input parameter (p) and another input parameter (q) of the set, when
(d) the given input parameter (p) and the another input parameter (q) occur in at least one atomic condition; or
(e) the given input parameter (p) and the another input parameter (q) occur in the condition-on-parameters (ϕ) within a sub-formula of the form ϕₚ OR ϕ_{q}, wherein p occurs in ϕₚ and q occurs in ϕ_{q} provided that the condition-on-parameters (ϕ) has been transformed to Negation Normal Form.

7. A method according to claim 1, wherein the single-phase query structure enables the input parameters of the set to be queried independently from each other, in an arbitrary order.

8. A method according to claim 1, wherein the multi-phase query structure enables the input parameters of the set to be queried based upon the dependencies therebetween, in a sequential manner.

9. A method according to claim 7, wherein in the multi-phase query structure,
a first phase pertains to
partitioning the inputs to one or more sub-sets of mutually dependent input parameters,
determining a condition for each of the subset, wherein all input parameters of a given sub-set are queried sequentially;
a second phase pertains to defining a sequence of querying for each sub-set;
a third phase pertains to querying values and determining constraints for all elements of the sequence with respect to the condition-on-parameters, by fixing values of preceding elements of a given element, and eliminating succeeding elements of the given element.

10. A method according to claim 9, wherein eliminating the succeeding elements of the given element comprises:
eliminating at least one element using numeric inequalities.

11. A system for deriving a procedure for querying data, the system comprising a server arrangement that is configured to:
(I) define a set of input parameters;
(II) define a condition which the set of input parameters have to fulfil;
(III) analyse dependencies between input parameters of the set;
(IV) create a query structure for querying the data, based upon the analysed dependencies, wherein:
when the input parameters are independent, the created query structure is a single-phase query structure; and
when the input parameters are dependent, the created query structure is a multi-phase query structure; and
(V) use the created query structure for querying the data.

12. A system according to claim 11, wherein the condition defined at (II) comprises a set of atomic conditions that are inter-related via Boolean connectives, the set of atomic conditions being numeric conditions and/or relational conditions.

13. A system according to claim 11, wherein the server arrangement is further configured to:
process the condition defined at (II), to existentially abstract the set of atomic conditions corresponding thereto; and
evaluate the set of atomic conditions without utilising values of the input parameters, to obtain a condition-on-parameters (ϕ).

14. A system according to claim 13, wherein, to evaluate the set of atomic conditions, the server arrangement employs at least one decision tree and/or at least one branching operation.

15. A system according to claim 13, wherein the condition-on-parameters (ϕ) is in one of: Boolean circuit, unrestricted Boolean formula or a Negation Normal Form (NNF).

16. A system according to claim 13, wherein the server arrangement is configured to analyse the dependencies between the input parameters of the set at (III), based upon the set of atomic conditions and/or the condition-on-parameters (ϕ), and wherein:
a given input parameter (p) of the set is identified to be independent with respect to other input parameters of the set, when the condition-on-parameters (ϕ) is logically equivalent to a formula of the form ϕₚ AND ϕ′, wherein
(A) p occurs in ϕₚ;
(B) p does not occur in ϕ′; and
(C) the other input parameters of the set do not occur in ϕₚ; and
a dependency is identified between the given input parameter (p) and another input parameter (q) of the set, when
(D) the given input parameter (p) and the another input parameter (q) occur in at least one atomic condition; or
(E) the given input parameter (p) and the another input parameter (q) occur in the condition-on-parameters (ϕ) within a sub-formula of the form ϕₚ OR ϕ_{q}, wherein p occurs in ϕₚ and q occurs in ϕ_{q} provided that the condition-on-parameters (ϕ) has been transformed to NNF

17. A system according to claim 11, wherein the single-phase query structure enables the input parameters of the set to be queried independently from each other, in an arbitrary manner.

18. A system according to claim 11, wherein the multi-phase query structure enables the input parameters of the set to be queried based upon the dependencies therebetween, in a sequential manner.

19. A system according to claim 18, wherein in the multi-phase query structure, a first phase pertains to
partition the inputs to one or more sub-sets of mutually dependent input parameters,
determine a condition for each of the subset, wherein all input parameters of a given sub-set are queried sequentially;
a second phase pertains to define a sequence of querying for each sub-set;
a third phase pertains to query of values and to determine constraints for all elements of the sequence with respect to the condition-on-parameters, by fixing values of preceding elements of a given element, and eliminating succeeding elements of the given element. Preceding elements refer to all ready queried elements. Furthermore the different sub-sets can be queried in any order or interleaved in any manner.

20. A system according to claim 18, wherein the server arrangement is configured to eliminate the succeeding elements of the given element via:
elimination of at least one element using numeric inequalities.
